(19) United States
(12) Patent Application Publication
(10) Pub. No.: US 2004/0221936 A1
(43) Pub. Date: Nov. 11, 2004

(54) Vehicle tire with a tread rubber profile

(75) Inventors: Hinnerk Kaiser, Hanover (DE); Akif Celik, Hanover (DE)

Correspondence Address: GREENBLUM & BERNSTEIN, P.L.C., 1950 ROLAND CLARKE PLACE, RESTON, VA, 20191, US

(73) Assignee: Continental Aktiengesellschaft, Hannover (DE)

(21) Appl. No.: 10/803,901

(22) Filed: Mar. 19, 2004

(30) Foreign Application Priority Data
Mar. 20, 2003 (DE) 103 12 488.8

(51) Int. Cl. B60C 11/03

(52) U.S. Cl. 152/209.1

(57) ABSTRACT

Vehicle tire having a tread rubber profile which includes grooves running in a circumferential direction, diagonal grooves, two shoulder block rows and a pair of center block rows arranged between the two shoulder block rows. Each of the two shoulder block rows and each of the pair of center block rows include blocks. Each of the blocks include a plurality of fine indents running generally parallel to one another. The tread rubber profile has a road contact area defined by a width Y and a center profile area defined by a width X, whereby the width Y at least partially encompasses the two shoulder block rows and whereby the width X is generally defined by axial outer edges of the pair of center block rows. A ratio of the width Y to the width X is between approximately 1−(D_{R}−100)×1.5 and approximately 1−(D_{R}−100)×5, whereby D_{R} represents a diameter of a rim to which the vehicle tire can be connected. This Abstract is not intended to define the invention disclosed in the specification, nor intended to limit the scope of the invention in any way.

### CROSS-REFERENCE TO RELATED APPLICATIONS

The present application claims priority under 35 U.S.C. §119 of German Patent Application No. 103 12 488.8, filed on Mar. 20, 2003, the disclosure of which is expressly incorporated by reference herein in its entirety.

### BACKGROUND OF THE INVENTION

1. Field of the Invention

The invention relates to a vehicle tire, in particular a winter tire, with a tread rubber profile which includes grooves running in the circumferential direction and diagonal grooves. The tire also includes two shoulder block rows lying axially outside and a pair of center block rows arranged between the shoulder block rows. The blocks of the shoulder block rows and the center block rows are respectively provided with a plurality of fine indents running parallel to one another. The borders of a road contact area of the vehicle tire pass through the shoulder block rows and a profile center is delimited by axial outer edges of the center block rows.

2. Discussion of Background Information

Vehicle pneumatic tires with such tread rubber profiles are known in different embodiment variants, e.g., through EP 0 729 854 B1. In the design of tread rubber profiles for winter tires it is important to take into account the very different demands on such a tire, since winter tires need to be satisfactory on dry roads as well as on wet roads and under wintry driving conditions. It is therefore most important to coordinate the various profile properties as well as possible so that the tire, e.g., responds in wet grip and features good steering and traction behavior and braking behavior under wintry driving conditions, e.g., on snow and ice.

The number of effective edges is to be increased though fine indents in order to improve the traction behavior, in particular on wintry roads.

A particular problem which faces the developer of such vehicle tires is transferring a selected profile design of a tire of a specific dimension to another tire of different dimension, e.g., the profile of a tire of the dimension 135/80 R13 to a tire with the dimension 225/45 R17. With a transfer of the profile of the tire 135/80 R13 according to scale, the much broader tire of the dimension 225/45 R17 would in fact make a tire that features completely different properties under driving conditions since, if this profile design were transferred to scale, the ratios would be completely changed, in particular with regard to the size and length of the effective edges in the shoulder area and in the profile center area.

### SUMMARY OF THE INVENTION

Accordingly, the invention aims to create a tire of the type described at the outset wherein the profile can be transferred to different tire sizes and tire widths regardless of dimensions.

The invention provides for a vehicle tire, in particular a winter tire, with a tread rubber profile which includes grooves running in the circumferential direction and diagonal grooves. The tire also includes two shoulder block rows lying axially outside and a pair of center block rows arranged between the shoulder block rows. The blocks of the shoulder block rows and the center block rows are respectively provided with a plurality of fine indents running parallel to one another. The borders of a road contact area of the vehicle tire pass through the shoulder block rows and a profile center is delimited by axial outer edges of the center block rows.

The invention also provides for a ratio of the width of the road contact area to the width of the profile center to be between approximately 1(D_{R}−100)×1.5 and approximately 1(D_{R}−100)×5, and preferably approximately 1−(D_{R}100)×3.3, whereby D_{R} is the diameter of the rim to which the vehicle pneumatic tire can be connected.

The invention also aims to ensure that, in a surprisingly simple way, the profile is dynamically adapted to different tire widths and sizes. The invention is, in fact, based on the surprising finding that tire properties can be assigned locally to profile areas in the road contact area. The profile center is hereby essentially responsible for the winter properties with regard to ice and snow traction, whereas the profile shoulder is responsible for the dry properties, namely for handling and braking power. Through the dynamic design of the width ratios of road contact area to profile center, the profile center becomes disproportionately narrow with greater dimensions, whereas the profile shoulder becomes disproportionately wide with greater dimensions.

This can make it possible to achieve the effect that the circumferential grooves are optimally positioned in the contact surface and that with even wear and good dry handling a high aquaplaning standard results.

In an advantageous further development of the invention, fine indents can be arranged in the center block rows, which indents, viewed in plan view, are embodied in a stepped or saw-toothed manner and respectively comprise alternately consecutive long sections running at least essentially in the profile crosswise direction and short indent sections, and fine sinusoidal indents can be arranged in the shoulder block rows, which indents comprise a row of several wave structures each of which is in itself at least essentially symmetrical.

This embodiment with sinusoidal fine indents in the shoulder block rows and with highly interlocking stepped plates in the profile center produces a greater rigidity of the shoulder block profiles and a higher flexibility of the center profile blocks. This embodiment results in good traction behavior and in good dry handling, whereby the embodiment of the shoulder block profiles with fine sinusoidal indents is responsible for the good dry handling, whereas the stepped plates in the profile center ensure the essential winter properties of the tire.

The different fine indent designs of the center or of the shoulder block rows permits a decoupling of the winter properties and dry properties. The shoulder block rows alone guarantee good dry driving behavior, whereas the profile block center ensures the tire's suitability for winter conditions.

The combination of different fine indent shapes is already known per se through EP 0 669 216 B1, which describes a vehicle tire with an asymmetrical profile that features stepped plates on the inside relative to the vehicle and sinusoidal plates on the outside relative to the vehicle. With this concept, however, the different concepts of traction properties and dry driving behavior are to be assigned to the inner side of the tire or the outer side of the tire, but not to the two outer sides and the center area.

In a practical embodiment of the invention, the width of the fine indents of the shoulder block rows can be narrower than the fine stepped indents of the profile block center.

In further practical embodiments of the invention, fine indents can be arranged in the blocks of the shoulder block rows, which indents are inclined at an angle of between approximately 70° and approximately 85° to the tire circumferential direction, and fine indents can be arranged in the blocks of the center block rows, which indents run at an angle of between approximately 80° and approximately 90° to the tire circumferential direction, whereby the angle difference is between approximately 5° and approximately 15°, in particular up to approximately 10°.

Furthermore, using a swept back course of the diagonal grooves, the invention provides for a vehicle tire has a tread rubber profile bound to the rotational direction.

In a particularly preferred embodiment of the invention, the circumferential groove can serve as the axis of symmetry, whereby it can further be provided that both halves of the tread rubber profile to the right and to the left of the circumferential groove are displaced in the circumferential direction by between approximately 5 mm and approximately 50 mm, preferably approximately 11.5 mm. A displacement or a slight twisting of one tread rubber half to the mirror-inverted other half of the tread rubber profile also produces an edge displacement, which has a positive effect on a low noise development. A displacement of 11.5 mm has hereby proven to be particularly effective for noise reduction.

The invention also provides for a vehicle tire comprising a tread rubber profile comprising grooves running in a circumferential direction, diagonal grooves, two shoulder block rows and a pair of center block rows arranged between the two shoulder block rows. Each of the two shoulder block rows and each of the pair of center block rows comprises blocks. Each of the blocks comprise a plurality of fine indents running generally parallel to one another. The tread rubber profile has a road contact area defined by a width Y and a center profile area defined by a width X, whereby the width Y at least partially encompasses the two shoulder block rows and whereby the width X is generally defined by axial outer edges of the pair of center block rows. A ratio of the width Y to the width X is between approximately 1(D_{R}−100)×1.5 and approximately 1−(D_{R}−100)×5, whereby D_{R} represents a diameter of a rim to which the vehicle tire can be connected.

The vehicle tire may be a winter tire. The tire may be a pneumatic tire and the ratio may comprise approximately 1(D_{R}−100)×3.3. The value D_{R} may comprise one of 14 inches, 15 inches, 16 inches and 17 inches. The value D_{R} may comprise a value between 12 inches and 21 inches. The value D_{R} may comprise a value greater than 13 inches. Each of the plurality of fine indents of the blocks of the pair of center block rows may have one of a stepped configuration and a saw-toothed configuration.

Each of the plurality of fine indents of the blocks of the pair of center block rows may comprise long sections running at least essentially in a crosswise direction and short sections. The long sections may be alternating consecutive long sections.

Each of the plurality of fine indents of the blocks of the two shoulder block rows may comprise indents arranged in a sinusoidal configuration. Each of the plurality of fine indents of the blocks of the two shoulder block rows may comprise sinusoidal indents. Each of the sinusoidal indents may comprise a row of essentially symmetrical wave structures.

A width of the plurality of fine indents of the blocks of the two shoulder block rows may be narrower than a width of the plurality of fine indents of the blocks of the pair of center block rows.

One of the grooves running in a circumferential direction may comprise a central circumferential groove, whereby the central circumferential groove forms an axis of symmetry of the tread rubber profile. At least some of the blocks may be arranged on opposite sides of the central circumferential groove and may be spaced from the axis of symmetry between approximately 5 mm and approximately 50 mm. At least some of the blocks may be arranged on opposite sides of the central circumferential groove are spaced from the axis of symmetry by approximately 11.5 mm.

The plurality of fine indents of the blocks of the two shoulder block rows may be oriented at an angle of between approximately 70 degrees and approximately 85 degrees relative to the circumferential direction.

The plurality of fine indents of the blocks of the pair of center block rows may be oriented at an angle of between approximately 80 degrees and approximately 90 degrees relative to the circumferential direction.

The plurality of fine indents of the blocks of the two shoulder block rows may be oriented at a first angle relative to the circumferential direction and the plurality of fine indents of the blocks of the pair of center block rows may be oriented at a second angle relative to the circumferential direction, and the first and second angles may comprise values which are between approximately 5 degrees and approximately 15 degrees. The first and second angles may comprise a value which is approximately 10 degrees. The first and second angles may comprise a value which is equal to or less than approximately 10 degrees.

The diagonal grooves may comprise a swept-back configuration.

The invention also provides for a vehicle tire comprising a tread rubber profile comprising a center circumferential groove, a left side shoulder block row, a right side shoulder block row, a left side inner block row and a right side inner block row, a left side circumferential groove and a right side circumferential groove. Each of the left and right side shoulder block rows and each of the left and right side inner block rows comprise blocks and diagonal grooves. Each of the blocks comprise a plurality of fine indents running generally parallel to one another. The tread rubber profile has a road contact area defined by a width Y and a center profile area defined by a width X, whereby the width Y at least partially encompasses the left and right shoulder block rows and whereby the width X is generally defined by axial outer edges of the left and right inner block rows.

A ratio of the width Y to the width X may be between approximately 1−(D_{R}−100)×1.5 and approximately 1−(D_{R}−100)×5, whereby D_{R} represents a diameter of a rim to which the vehicle tire can be connected.

The invention also provides for a vehicle tire comprising a tread rubber profile comprising a center circumferential groove, a left side shoulder block row, a right side shoulder block row, a left side inner block row and a right side inner block row, a left side circumferential groove and a right side circumferential groove. Each of the left and right side shoulder block rows and each of the left and right side inner block rows comprises blocks and diagonal grooves. The tread rubber profile has a road contact area defined by a width Y and a center profile area defined by a width X, whereby the width Y at least partially encompasses the left and right shoulder block rows and whereby the width X is generally defined by axial outer edges of the left and right inner block rows. The center circumferential groove is generally narrower than the left and right side circumferential grooves and the left and right side shoulder block rows comprise a width that is greater than a width of either of the left and right inner block rows.

The diagonal grooves may comprise a width that is less than a width of either of the center circumferential groove and the left and right side circumferential grooves. Each of the blocks may comprise edges delineating the diagonal grooves which are oriented at an angle that is not perpendicular to a circumferential direction. Each of the blocks may comprise a plurality of fine indents running generally parallel to one another. A ratio of the width Y to the width X can be between approximately 1×(D_{R}−100)×1.5 and approximately 1−(D_{R}−100)×5, whereby D_{R} represents a diameter of a rim to which the vehicle tire can be connected. The vehicle tire may be a winter tire.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an exemplary embodiment of a tread rubber profile according to the invention in plan view; and

FIG. 2 shows the tread rubber profile from FIG. 1 in three different dimensions shown to scale.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

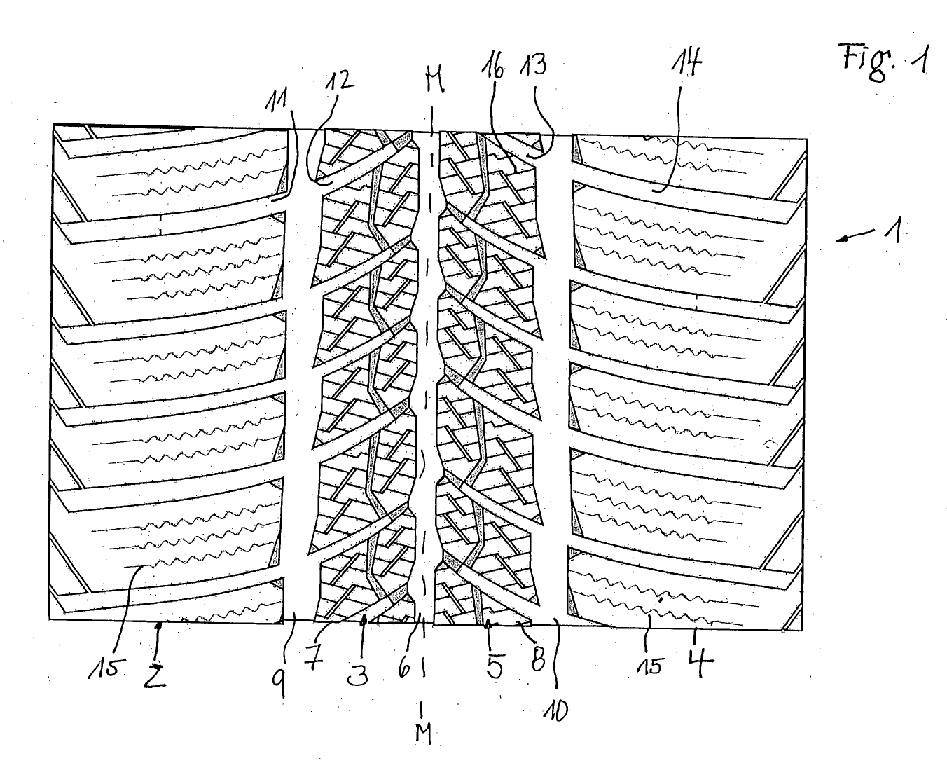

FIG. 1 shows an exemplary embodiment of a tread rubber profile 1. The tread rubber profile 1 is bound to the direction of motion. A shoulder block row 2, a shoulder block row 4, and a pair of center block rows 3, 5 are arranged in each half of the tread rubber. A circumferential groove 6 is arranged generally along a center circumferential line M/M of the profile 1. The groove, through the embodiment of the block edges of the blocks 7, 8 of the center block rows 3, 5 bordering it, has slightly serrated flanks and acts as the axis of symmetry of the two profile halves. Thus, one half includes block rows 4 and 5 while another half includes block rows 2 and 3. Each shoulder block row 2, 4 is separated from the center block row 3, 5 adjacent to it by a respective wide circumferential groove 9, 10.

A further division of the tread rubber profile 1 is made by diagonal grooves 11 through 14, the entire course of which is selected such that they run beginning between the blocks 7, 8 of the center block rows 3, 5 at least essentially continuously up to the tread rubber edge and beyond this, whereby the type of tread rubber profile called “swept back” is produced which is typical of many profiles bound to the direction of motion. The diagonal grooves 12, 13 of the center block rows 3, 5 form an angle of between approximately 50 degrees and approximately 70 degrees relative to the center circumferential line M/M. The diagonal grooves 11, 14 of the shoulder block rows 2, 4 form an angle of between approximately 70 degrees and approximately 85 degrees.

The shoulder block rows 2, 4 respectively feature fine indents 15 (i.e., thin and/or shallow indentations or grooves) that respectively feature a sinusoidal course and/or configuration and which run generally parallel to one another and to the diagonal grooves 11, 14.

The blocks 7, 8 of the center block rows 3, 5 feature fine indents 16 (i.e., thin and/or shallow indentations or grooves) that are embodied in plan view in a stepped or saw-toothed manner and/or configuration. The width of the fine indents 16 of the center block rows 3, 5 can generally be approximately double the size of the width of the fine indents 15 of the shoulder block rows 2, 4.

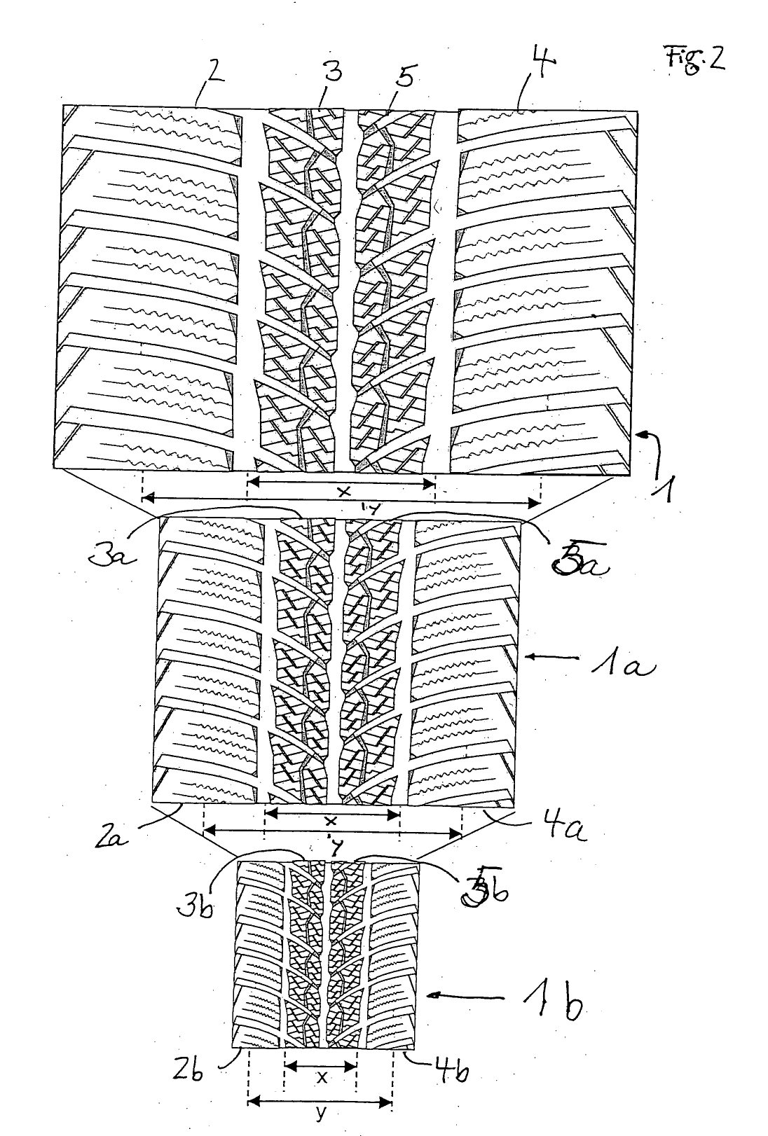

FIG. 2 shows the tire profile from FIG. 1 compared with essentially identical tire profiles, 1a and 1b of other tire dimensions. The arrows X respectively represent the axial width of the pair of center block rows 3, 5; 3a, 5a; and 3b, 5b. The arrow Y shows the width of the road contact area, the borders of which respectively run through the shoulder block rows 2, 4; 2a, 4a; and 2b, 4b.

The profile 1 is one of the tire dimension 225/45 R17, while the profile 1a is one of the tire dimension 195/65 R15 and the profile 1b one of the tire dimension 135/80 R13.

As can be seen in FIG. 2, in particular, the shoulder block rows 2, 4 of the profile 1 are each disproportionately wider than an overall width of the profile center block rows 3, 5. Accordingly, the profile center block rows 3, 5 of the profile 1 is disproportionately narrower (relative to rows 2, 4) the when compared to the profiles 1a and 1b of the smaller tire dimensions (relative to rows 2a, 4a and rows 2b, 4b).

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### List of Reference Numbers

| | |
|---|---|
| 1 | Tread rubber profile |
| 2 | Shoulder block row |
| 3 | Center block row |
| 4 | Shoulder block row |
| 5 | Center block row |
| 6 | Circumferential groove |
| 7 | Block |
| 8 | Block |
| 9 | Circumferential groove |
| 10 | Circumferential groove |
| 11 | Diagonal grooves |
| 12 | Diagonal grooves |
| 13 | Diagonal grooves |
| 14 | Diagonal grooves |
| 15 | Fine indent |
| 16 | Fine indent |
| M—M | Circumferential center line |

What is claimed:

1. A vehicle tire comprising:
a tread rubber profile comprising grooves running in a circumferential direction, diagonal grooves, two shoulder block rows and a pair of center block rows arranged between the two shoulder block rows;
each of the two shoulder block rows and each of the pair of center block rows comprising blocks;
each of the blocks comprising a plurality of fine indents running generally parallel to one another; and
the tread rubber profile having a road contact area defined by a width Y and a center profile area defined by a width X, whereby the width Y at least partially encompasses the two shoulder block rows and whereby the width X is generally defined by axial outer edges of the pair of center block rows,
wherein a ratio of the widths Y to the width X is between approximately 1−(D_{R}−100)×1.5 and approximately 1−(D_{R}−100)×5, whereby D_{R} represents a diameter of a rim to which the vehicle tire can be connected.

2. The tire of claim 1, wherein the vehicle tire is a winter tire.

3. The tire of claim 1, wherein the ration comprises approximately 1−(D_{R}−100)×3.3.

4. The tire of claim 1, wherein D_{R} comprises one of 14 inches, 15 inches, 16 inches and 17 inches.

5. The tire of claim 1, wherein D_{R} comprises a value between 12 inches and 21 inches.

6. The tire of claim 1, wherein D_{R} comprises a value greater than 13 inches.

7. The tire of claim 1, wherein each of the plurality of fine indents of the blocks of the pair of center block rows have one of a stepped configuration and a saw-toothed configuration.

8. The tire of claim 1, wherein each of the plurality of fine indents of the blocks of the pair of center block rows comprise long sections running at least essentially in a crosswise direction and short sections.

9. The tire of claim 8, wherein the long sections are alternating consecutive long sections.

10. The tire of claim 1, wherein each of the plurality of fine indents of the blocks of the two shoulder block rows comprise indents arranged in a sinusoidal configuration.

11. The tire of claim 1, wherein each of the plurality of fine indents of the blocks of the two shoulder block rows comprise sinusoidal indents.

12. The tire of claim 11, wherein each of the sinusoidal indents comprises a row of essentially symmetrical wave structures.

13. The tire of claim 1, wherein a width of the plurality of fine indents of the blocks of the two shoulder block rows is narrower than a width of the plurality of fine indents of the blocks of the pair of center block rows.

14. The tire of claim 1, wherein one of the grooves running in a circumferential direction comprises a central circumferential groove, whereby the central circumferential groove forms an axis of symmetry of the tread rubber profile.

15. The tire of claim 14, wherein at least some of the blocks arranged on opposite sides of the central circumferential groove are spaced from the axis of symmetry between approximately 5 mm and approximately 50 mm.

16. The tire of claim 14, wherein at least some of the blocks arranged on opposite sides of the central circumferential groove are spaced from the axis of symmetry by approximately 11.5 mm.

17. The tire of claim 1, wherein the plurality of fine indents of the blocks of the two shoulder block rows are oriented at an angle of between approximately 70 degrees and approximately 85 degrees relative to the circumferential direction.

18. The tire of claim 1, wherein the plurality of fine indents of the blocks of the pair of center block rows are oriented at an angle of between approximately 80 degrees and approximately 90 degrees relative to the circumferential direction.

19. The tire of claim 1, wherein the plurality of fine indents of the blocks of the two shoulder block rows are oriented at a first angle relative to the circumferential direction and wherein the plurality of fine indents of the blocks of the pair of center block rows are oriented at a second angle relative to the circumferential direction, and wherein the first and second angles comprise values which are between approximately 5 degrees and approximately 15 degrees.

20. The tire of claim 19, wherein the first and second angles comprise a value which is approximately 10 degrees.

21. The tire of claim 19, wherein the first and second angles comprise a value which is equal to or less than approximately 10 degrees.

22. The tire of claim 1, wherein the diagonal grooves comprise a swept-back configuration.

23. A vehicle tire comprising:
a tread rubber profile comprising a center circumferential groove, a left side shoulder block row, a right side shoulder block row, a left side inner block row and a right side inner block row, a left side circumferential groove and a right side circumferential groove;
each of the left and right side shoulder block rows and each of the left and right side inner block rows comprising blocks and diagonal grooves; and
each of the blocks comprising a plurality of fine indents running generally parallel to one another,
wherein the tread rubber profile has a road contact area defined by a width Y and a center profile area defined by a width X, whereby the width Y at least partially encompasses the left and right shoulder block rows and whereby the width X is generally defined by axial outer edges of the left and right inner block rows.

24. The tire of claim 23, wherein a ratio of the width Y to the width X is between approximately 1−(D_{R}−100)×1.5 and approximately 1−(D_{R}−100)×5, whereby D_{R} represents a diameter of a rim to which the vehicle tire can be connected.

25. A vehicle tire comprising:
a tread rubber profile comprising a center circumferential groove, a left side shoulder block row, a right side shoulder block row, a left side inner block row and a right side inner block row, a left side circumferential groove and a right side circumferential groove;
each of the left and right side shoulder block rows and each of the left and right side inner block rows comprising blocks and diagonal grooves; and
the tread rubber profile having a road contact area defined by a width Y and a center profile area defined by a width X, whereby the width Y at least partially encompasses the left and right shoulder block rows and whereby the width X is generally defined by axial outer edges of the left and right inner block rows,
wherein the center circumferential groove is generally narrower than the left and right side circumferential grooves,
wherein the left and right side shoulder block rows comprise a width that is greater than a width of either of the left and right inner block rows.

26. The tire of claim 25, wherein the diagonal grooves comprise a width that is less than a width of either of the center circumferential groove and the left and right side circumferential grooves.

27. The tire of claim 25, wherein each of the blocks comprise edges delineating the diagonal grooves which are oriented at an angle that is not perpendicular to a circumferential direction.

28. The tire of claim 25, wherein each of the blocks comprises a plurality of fine indents running generally parallel to one another.

29. The tire of claim 25, wherein a ratio of the width Y to the width X is between approximately 1−(D_{R}−100)×1.5 and approximately 1−(D_{R}−100)×5, whereby D_{R} represents a diameter of a rim to which the vehicle tire can be connected.

30. The tire of claim 25, wherein the vehicle tire is a winter tire.
